(19) United States
(12) Patent Application Publication
(10) Pub. No.: US 2016/0154560 A1
(43) Pub. Date: Jun. 2, 2016

(54) INFORMATION PROCESSING DEVICE, INFORMATION PROCESSING METHOD, AND A PROGRAM FOR INFORMATION PROCESSING

(71) Applicant: BUFFALO INC., Nagoya-shi (JP)

(72) Inventors: Masayuki NEMOTO, Nagoya-shi (JP); Yasuyuki MANAKA, Nagoya-shi (JP)

(73) Assignee: BUFFALO INC., Nagoya-shi (JP)

(21) Appl. No.: 14/940,736

(22) Filed: Nov. 13, 2015

(30) Foreign Application Priority Data
Nov. 28, 2014 (JP) 2014-241405

(51) Int. Cl. G06F 3/0488; G06F 3/0484

(52) U.S. Cl. CPC G06F 3/0488; G06F 3/04842

(57) ABSTRACT

An information processing device that includes circuitry that: generates first image data for a first image to be displayed on a display screen of a display; causes the display to display the first image on the display screen; receives an input signal in response to a swipe input having a direction; generates second image data for a second image to be displayed on the display screen in response to the received input signal; and causes the display to display a third image on a portion of the display screen, the portion of the display screen being on a side of the display screen opposite the direction of the swipe input, while the display is generating the second image data to be displayed on the display screen.

### CROSS-REFERENCE TO RELATED APPLICATIONS

The present patent application claims the right of priority under 35 U.S.C. §119(a)-(d) of Japanese Patent Application No. 2014-241405, filed on 28 Nov. 2014.

### BACKGROUND OF THE DISCLOSURE

1. Field of the Disclosure

This disclosure relates to an information processing device with which a display screen shows a display image, an information processing method, and a program for information processing devices.

2. Description of Related Art

A technique for storing content data imaged with imaging devices, such as a digital camera or a smart phone, in a memory of an image management device, such as a Personal Computer (PC), and browsing content data in this image management device is known. In this case, the technique connects an imaging device and an image management device by a USB (Universal Serial Bus) cable, and browses content data with both an imaging device and an image management device.

Moreover, in a User Interface (UI) screen, which generally has a hierarchical structure, if an input operation, which is called a swipe and which a user makes, is a movement on the surface of a touchscreen in one direction is carried out, the image of the hierarchical structure can be switched.

Such a technique is proposed, for example, in patent documents (1) Unexamined Japanese Patent No. 2012-226516, (2) Japanese Patent 5313325, and (3) Unexamined Japanese Patent No. 2012-226520.

### BRIEF SUMMARY OF THE DISCLOSURE

The present disclosure provides an information processing device that includes circuitry that: generates first image data for a first image to be displayed on a display screen of a display; causes the display to display the first image on the display screen; receives an input signal in response to a swipe input having a direction; generates second image data for a second image to be displayed on the display screen in response to the received input signal; and causes the display to display a third image on a portion of the display screen, the portion of the display screen being on a side of the display screen opposite the direction of the swipe input, while the display is generating the second image data to be displayed on the display screen.

### BRIEF DESCRIPTION OF THE DRAWINGS

FIG. 1 is a figure which shows a schematic structure of an information processing system in a first embodiment of the disclosure.

FIG. 2 is a block diagram which shows a schematic structure of an image management device in the first embodiment.

FIG. 3 is a block diagram which shows a schematic structure of an information processing device in the first embodiment.

FIG. 4 is a functional block diagram which shows the functional structure of the information processing system of the first embodiment.

FIG. 5 is a figure which shows the data structure of the content file stored in a memory of the image management device in the first embodiment.

FIG. 6 is a figure for explaining an example of the storing form of a content file stored in the memory of the image management device in the first embodiment.

FIG. 7 is a flowchart for explaining an example of operation of the information processing system in the first embodiment.

FIG. 8 is a flowchart for explaining an example of operation of the information processing system in the first embodiment.

FIG. 9A and FIG. 9B show examples of display images shown on the display screen of the information processing device in the first embodiment.

FIG. 10A and FIG. 10B show examples of display images shown on the display screen of the information processing device in the first embodiment.

FIG. 11A and FIG. 11B show other examples of display images shown on the display screen of the information processing device in the first embodiment.

FIG. 12 is a functional block diagram which shows the functional structure of the information processing system in a second embodiment of this disclosure.

### DETAILED DESCRIPTION OF THE DISCLOSURE

When the technique disclosed by patent documents 1-3 is applied to the technique of browsing content data with both an imaging device and an image management device, the transfer operations of content data occur with the switch of an image. When a time required for these transfer operations was longer than the image switching time and image switching was performed, the situation where all content data was not shown in the switched image may have arisen. Such a display control aspect also had a possibility of impairing usability.

This disclosure is made in view of the subjects mentioned above. Provision of the information processing device, information processing system, and the display control method for the information processing device, and a program which can perform display control which, as much as possible, does not impair the usability in the case of image switching is one of the objectives.

This disclosure is applied to an information processing device which has the following. A display device on which a display image is shown on a display screen. A display image generation unit which generates the data for display image generation for showing the display image. A display control unit which controls the display screen based on the data for display image generation which the display image generation unit generated to show a display image on a display screen. The input unit which outputs an operation input signal based on the operation input on a display screen is provided. The display control unit controls a display screen as follows. If a first operation input signal based on an operation input in a first direction on the display screen is output from the input unit, generation of the data for display image generation for showing the first display image currently shown on the display screen, and also for a different second display image, is directed in a display image generation unit. While the display image generation unit is generating the data for display image generation for showing the second display image, a third display image which shows that the second display image is being generated is shown on a part of the display screen. This has solved at least one of the objects mentioned above.

Therefore, the user can visually recognize easily that the display image generation unit is generating the data for display image generation for showing a second display image while the third display image is shown.

Here, it is preferable that a display control unit controls a display screen as follows. While the display image generation unit is generating the data for display image generation for showing the second display image, the first display image is moved in the first direction only by a predetermined distance. Also, in connection with the first display image moving, the third display image is shown on an area of the display screen which the first display image no longer covers.

Or it is preferable that a display control unit controls a display screen as follows. While the display image generation unit is generating the data for display image generation for showing the second display image, the third display image is superimposed and shown on a part of the first display image.

Furthermore, it is preferable that the display control unit controls the display screen as follows. While the display image generation unit is generating the data for display image generation for showing the second display image, if a second operation input signal based on an operation input in a second direction different from the first direction on the display screen is output from the input unit, generation of the data for display image generation for showing the second display image is interrupted, and the first display image is again displayed in its entirety.

Moreover, it is preferable that the display control unit controls the display screen as follows. While the display image generation unit is generating the data for display image generation for showing the second display image, if an operation input signal based on the operation input on the display screen corresponding to the third display image is output from the input unit, generation of the data for display image generation for showing the second display image is interrupted, and the first display image is again displayed in its entirety.

Furthermore, it is preferable that the display control unit controls the display screen as follows. If the display image generation unit completes generation of the data for display image generation for showing the second display image, the first display image is moved in the first direction, and the first display image is made to leave from the display screen. The second display image is shown on the display screen.

Furthermore, it is preferable that the display control unit controls the display screen which shows information for identifying the second display image on the third display image. Moreover, it is preferable that the display image generation unit generates the first display image and the second display image based on predetermined permutation.

Furthermore, it is preferable that the input unit generates a first operation input signal based on a continuous movement operation input of a certain distance in the first direction on the display screen. In this case, as for the certain distance, it is more preferable that it is shorter than a predetermined distance. Moreover, it is preferable that the second direction is the opposite direction from the first direction.

Furthermore, preferably the display image generation unit generates the data for display image generation for showing an image corresponding to some content data on a single display image.

The information processing device can operate the image management device and perform data communication through a communication means. When content data is stored in the image management device, it is preferable for the display image generation unit to receive some content data from the image management device, and to generate the data for display image generation.

Moreover, this disclosure is applied to an information processing device which has the following. A display unit on which a display image is shown on a display screen, a display image generation unit which generates the data for display image generation for showing a display image, a display control unit which controls the display screen based on the data for display image generation which the display image generation unit generated to show a display image on a display screen, and an input unit which outputs an operation input signal based on the operation input on an operation surface different from the display screen or the operation input of a user gesture in front of an image recognition device (e.g., camera) is provided. The display control unit controls the display screen as follows. If a first operation input signal based on an operation input in a first direction on the operation surface is output from the input unit, generation of the data for display image generation for showing a second display image different from the first display image shown on the display screen is directed in the display image generation unit. While the display image generation unit is generating the data for display image generation for showing the second display image, a third display image which indicates that the second display image is in generation is shown on a part of the display screen. This solves at least one of the objects mentioned above.

Moreover, this disclosure is applied to information processing systems including a display unit on which a display image is shown on a display screen. A display image generation unit generates the data for display image generation for showing a display image. A display control unit controls the display screen based on the data for display image generation which the display image generation unit generated to show the display image on the display screen. The above components are included in an information processing device. An image management device stores content data. The data communication of the information processing device and the image management device can be carried out through a communication means. The information processing device is equipped with the input unit which outputs an operation input signal based on the operation input on a display screen. A display image generation unit receives content data from an image management device, and it generates the data for display image generation for showing the image corresponding to content data in a display image. A display control unit controls the display screen as follows. If a first operation input signal based on the operation input in a first direction on the display screen is output from the input unit, generation of the data for display image generation for showing a second display image different from the first display image shown on the display screen is directed in the display image generation unit. While the display image generation unit is generating the data for display image generation for showing the second display image, a third display image which displays that a second display image is in generation is shown on a part of the display screen. This has solved at least one of the objects mentioned above.

Furthermore, this disclosure is applied to a display control method for an information processing device which has a display unit on which a display image is displayed on a display screen, a display image generation unit which generates the data for display image generation for displaying a display image, and an input unit which outputs an operation input signal based on the operation input on a display screen. When a first operation input signal based on the operation input in a first direction on the display screen is output from the input unit, generation of the data for display image generation for showing the second display image different from the first display image shown on the display screen is directed in a display image generation unit. While the display image generation unit is generating the data for display image generation for displaying the second display image, the display screen is controlled to display the third display image which shows that the second display image is in generation on a part of the display screen. This has solved at least one of the objects mentioned above.

And this disclosure is applied to a program stored on a non-transitory recording medium run by a computer which includes the following: display unit on which a display image is shown on a display screen, a display image generation unit which generates the data for display image generation for showing a display image, a display control unit which controls a display screen based on the data for display image generation which the display image generation unit generated to show the display image on the display screen, and an input unit which outputs an operation input signal based on the operation input on a display screen. When this program is run by the computer, the display control unit is made to control the display screen as follows. If a first operation input signal based on the operation input in a first direction on the display screen is output from the input unit, generation of the data for display image generation for showing the second display image different from the first display image shown on the display screen is directed in the display image generation unit. While the display image generation unit is generating the data for display image generation for showing the second display image, the third display image which indicates that the second display image is in generation is shown on a part of the display screen. This has solved at least one of the objects mentioned above.

According to this disclosure, an information processing device which can perform display control and does not impair usability in the case of image switching as much as possible, an information processing system, and a display control method and program for an information processing device are realizable.

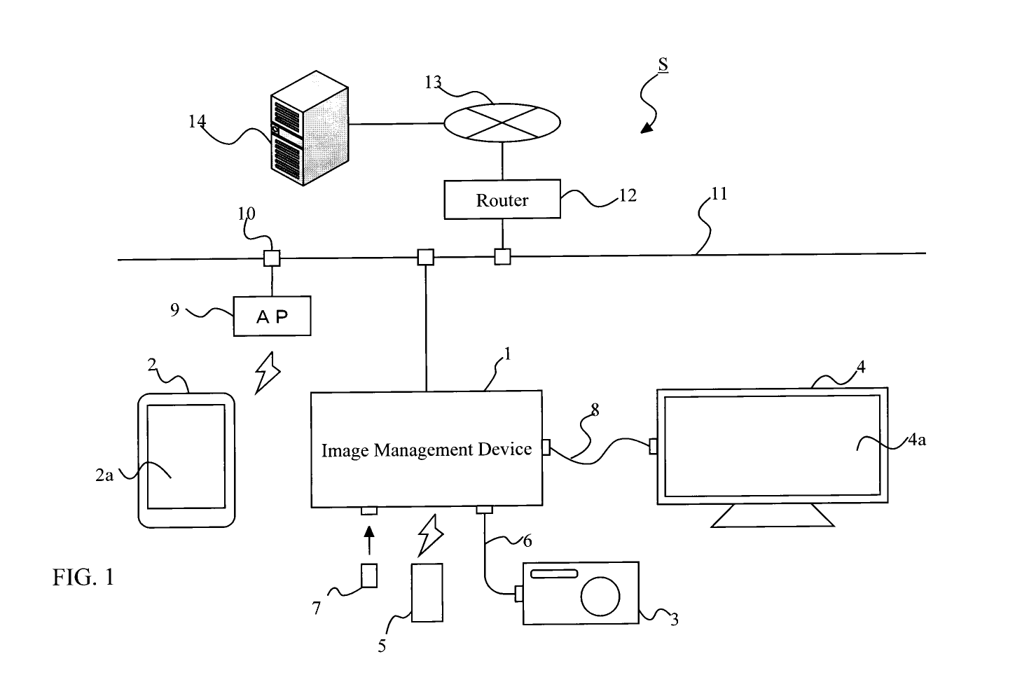

Hereinafter, with reference to the drawings, embodiments of information processing systems of this disclosure are explained. FIG. 1 is a figure which shows a schematic structure of an information processing system which is a first embodiment of this disclosure. In FIG. 1, the information processing system S of the first embodiment is equipped with an image management device 1, an information processing device 2, an imaging device 3, a display device 4, and an input instruction unit 5.

The image management device 1 takes in a content file imaged by the information processing device 2 and the imaging device 3. In addition, in this specification, although mainly explained using image files as content files, a content file may also be a movie file, etc., and there is no big change required in the description in this specification, and the disclosure applies equally to video files as still images. The details of the image management device 1 are discussed later. The information processing device 2 and the imaging device 3 take an image of a to-be-photographed object, and generate a content file. Imaging time data, etc., are provided to a part of this content file. The information processing device 2 is a smart phone or a tablet, for example, and the imaging device 3 is a digital camera, for example.

The content file imaged by the information processing device 2 is taken into the image management device 1 through a wireless communication means, such as a wireless Local Area Network (LAN). Moreover, the content file imaged by the imaging device 3 is taken into the image management device 1, for example, through a Universal Serial Bus (USB) cable 6 which is an example of a data transfer cable. Or, the content file imaged by the information processing device 2 and the imaging device 3 is stored in a memory card 7. The content file is loaded into the image management device 1 by inserting the memory card 7 in the image management device 1.

The display device 4 is connected to the image management device 1, for example, by a High Definition Multimedia Interface (HDMI®) cable 8, which is an example of a data transfer cable. The data for display image generation output from the image management device 1 are input into the display device 4 through this HDMI cable 8, and the display device 4 shows an image on a display image 4a based on the input data for display image generation. Or, the display device 4 may be connected to the image management device 1 by a cable which has an RCA connector which can transmit/receive a composite video signal, and a cable which has an S-video connector. Furthermore, the display device 4 may be connected to the image management device 1 by the cable which has a D-Terminal connector which can transmit/receive a component video signal. Or, the display device 4 may be connected to the image management device 1 through a wireless communication means, such as a wireless LAN. The display devices 4 can be a TV, a monitor, a smart phone, or a tablet, for example.

Similarly, the data for display image generation output from the image management device 1 are input into the information processing device 2 through a wireless communication means. The information processing device 2 shows an image on the display image 2a based on the input data for display image generation. Therefore, the information processing device 2 of this embodiment also has a function as a display device.

The input instruction unit 5 is a device which performs the input instruction with respect to the image management device 1, etc. This input instruction unit 5 that operates as what is called a remote control is equipped with a wired or wireless communication means, and transmits the input signal input when a user operates the input instruction unit 5 to the image management device 1 by a wired or a wireless communication means.

Wireless communications of the image management device 1 and the information processing device 2 are made possible between wireless access point (AP) 9 through the wireless communication means. This wireless access point 9 and image management device 1 are connected to LAN 11 through relay appliances 10, such as a switching hub. LAN 11 is connected to a Wide Area Network (WAN) 13, such as the Internet, through a router 12. Thereby, data transmission and reception is possible for the image management device 1 and the information processing device 2 between external servers 14 via WAN 13.

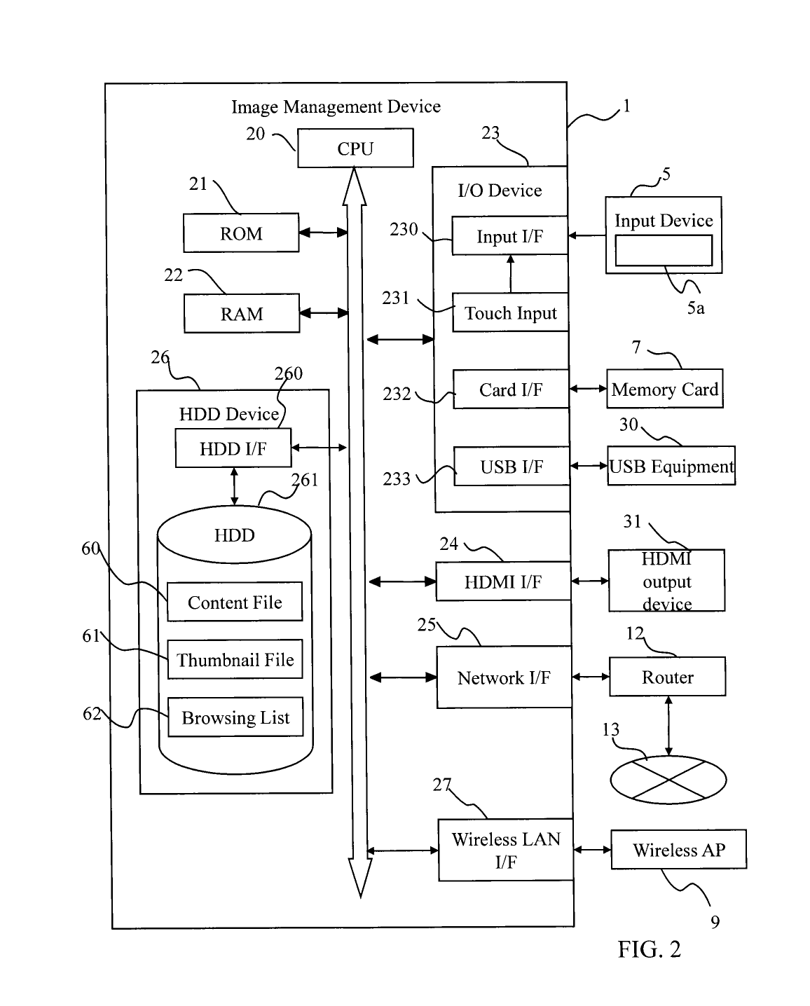

Next we discuss a structure of the image management device of the first embodiment. FIG. 2 is a block diagram which shows a schematic structure of the image management device 1 which the information processing system S comprises in the first embodiment of the disclosure. In FIG. 2, the image management device 1 is equipped with a Central Processing Unit (CPU) 20, a Read Only Memory (ROM) 21, a Random Access Memory (RAM) 22, an input-output device 23, an HDMI interface (I/F) 24, a network interface (I/F) 25, an HDD (Hard Disk Drive) device 26, and a wireless LAN interface (I/F) 27. These are mutually connected by a bus.

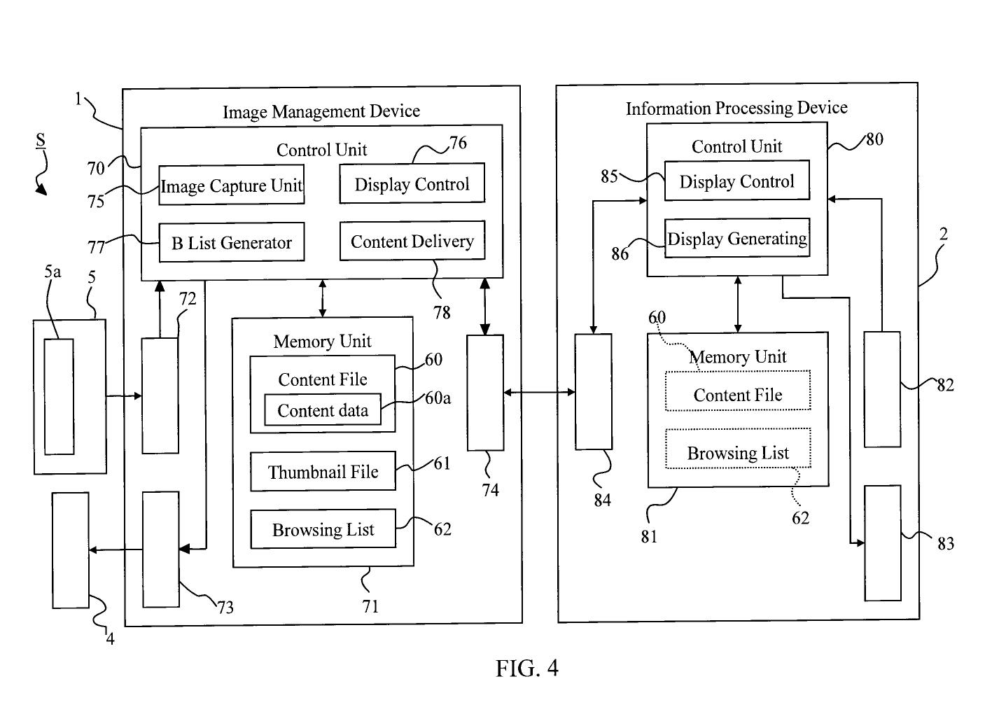

The CPU 20 controls the image management device 1 as a whole by running programs, such as a firmware stored in ROM 21 discussed below. Moreover, the CPU 20 operates also as each function part as shown in FIG. 4 by running the program stored in ROM 21. The operation of each functional part as shown in FIG. 4 is discussed below. Programs, such as the firmware mentioned above, are stored in ROM 21. The RAM 22 functions as a working memory of the image management device 1, and a program, data, etc., which are used during operation of the image management device 1 including the CPU 20 are stored in RAM 22.

The input-output device 23 is equipped with an input interface (I/F) 230, an input instruction unit 231, the card interface (I/F) 232, and the USB interface (I/F) 233.

The input instruction unit 231 and the input instruction unit 5 are connected to the input interface 230. A signal input is received when a user operates the input instruction unit 231 or the input instruction device 5. As the input instruction unit 231, an image capture direction button, etc., are examples. The input instruction device 5 is equipped with an operation part 5a corresponding to the operation position operated by the user. The input instruction device 5 will output the input signal corresponding to the input made using operation part 5a, when at least 1 operation part 5a is operated by the user. As the input instruction device 5, a remote control, a keyboard, a mouse, etc., are examples. As the operation part 5a, a button, etc., with which these remote controls is an example.

A card interface 232 is equipped with a card slot, and performs read-out/writing of data with respect to a memory card 7 inserted in this card slot. There is no limitation in the format of the memory card 7. A miniSD or microSD memory card or a Memory Stick® are examples. A USB interface 233 is equipped with a USB connector, and performs read-out/writing of the data according to a USB2.0 or USB3.0 specification with respect to the USB device 30 connected to this USB connector directly or through a USB cable 6. As the USB device 30, a USB flash memory or the imaging device 3 provided with a USB interface are examples.

The HDMI interface 24 is equipped with an HDMI connector, and outputs an audiovisual (AV) stream with respect to the HDMI output device 31 connected to this HDMI connector through HDMI cable 8. As the HDMI output device 31, the display device 4 is an example. The network interface 25 is equipped with a network connector, and the router 12 is connected to this network connector through a network cable. By the router 12 being connected to WAN 13, the transmission and reception of data may be carried out between external networks. The network interface 25 performs wired communication based on the Institute of Electrical and Electronics Engineers (IEEE) 802.3 specification, for example.

The HDD device 26 is equipped with HDD 261 and the HDD interface (I/F) 260. The HDD 261 is equipped with a disk which is a recording medium, a rotation unit which performs rotation of this disk, and a head which performs read-out/writing of data with respect to the disk. When there is a read-out/write-in command of the data with respect to the HDD 261, the HDD interface 260 controls the HDD 261, performs read-out/write-in control of the data, and outputs the read data. Moreover, the content file 60 taken in from the information processing device 2, the imaging device 3, etc., the thumbnail file 61, and the browsing list 62 are stored in the HDD 261.

The particular method of storing the content file 60 in HDD 261 is arbitrary. For example, a content file obtained by the imaging of the information processing device 2 or the imaging device 3, as mentioned above, may be stored in the memory card 7. The memory card 7 is inserted in the card slot of the card interface 232. The content file stored in the memory card 7 is copied to the HDD 261 using the input instruction unit 231. Moreover, a USB cable 6 connected to the imaging device 3 which imaged the content file may be inserted in the USB connector of the USB interface 233, and the content file stored in the imaging device 3 may also be copied to the HDD 261 using the input instruction unit 231. Moreover, wireless communications may be established between the wireless LAN interface 27 of the information processing device 2, the image management device 1, and the wireless access point 9. The content file stored in the information processing device 2, by direction from the information processing device 2, may also be copied to HDD 261 via wireless communications. Furthermore, a content file which exists in WAN 13 may be copied to HDD 261 through the router 12 and the network interface 25. The detailed structures of the content file 60, the thumbnail file 61, and the browsing list 62 are described below. In addition, although only one content file 60 is shown in FIG. 2, in the present example two or more content files 60 may be stored in the HDD 261.

The wireless LAN interface 27 performs wireless communications with the wireless access point 9, for example, based on the IEEE 802.11 standard. This wireless LAN interface 27 can operate the image management device 1 as a wireless LAN client.

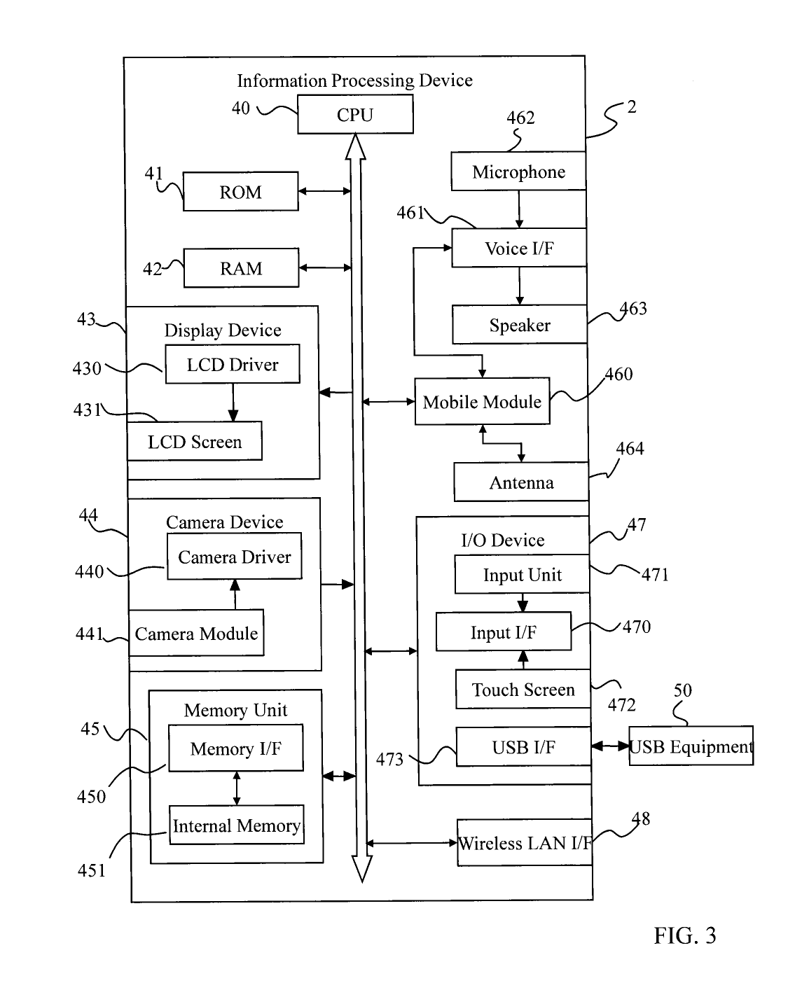

Next, the structure of the information processing device of the first embodiment is described. FIG. 3 is a block diagram which shows a schematic structure of the information processing device 2 of the information processing system S in the first embodiment. In FIG. 3, the information processing device 2 is equipped with a CPU 40, ROM 41, RAM 42, a display device 43, a camera device 44, an internal memory 45, a mobile communication module 460, an audio interface (I/F) 461, a microphone 462, a speaker 463, an antenna 464, an input-output device 47, and a wireless LAN interface 48. The CPU 40, ROM 41, RAM 42, the display device 43, the camera device 44, the internal memory 45, the mobile communication module 460, the input-output device 47, and the wireless LAN interface 48 are connected by a common bus.

The CPU 40, such as a processing circuitry, executes one or more sequences of one or more instructions contained in a memory. One or more processors in a multi-processing arrangement located in the information processing device 2 or a plurality of devices including a server on the Internet, may also be employed to execute the sequences of instructions contained in the memory. In alternative embodiments, hard-wired circuitry may be used in place of or in combination with software instructions. Thus, embodiments are not limited to any specific combination of hardware circuitry and software.

The CPU 40 performs operation control of the information processing device 2 by executing programs, such as firmware stored in ROM 41, and using RAM 42. Moreover, CPU 40 operates also as each functional part as shown in FIG. 4 by running the program stored in ROM 41. The operation of each function part shown in FIG. 4 is described below. The program and the various setting data of the above-mentioned firmware, etc., are stored in ROM 41. RAM42 operates as working memory of the information processing device 2, and various programs and data are stored in RAM 42.

The display device 43 is equipped with a liquid crystal panel 431, and a liquid-crystal driver 430 which drives the liquid crystal panel 431. The display screen is disposed at a surface of the information processing device 2, and the liquid crystal panel 431 is provided. When the data which comprise display image 2a are supplied to this liquid-crystal driver 430 from CPU 40, the liquid-crystal driver 430 will drive this liquid crystal panel 431 so that desired display image 2a may be shown on the display screen of the liquid crystal panel 431.

The camera device 44 is equipped with a camera driver 440 which drives the camera module 441. The camera module 441 can image the to-be-photographed object which exists outside of the information processing device 2. An image acquisition element and image formation parts, such as a lens for imaging a to-be-photographed object with respect to this image acquisition element, are included in the camera module 441. Preferably, an image formation part is equipped with a drive part which drives the image formation elements, such as lenses. The camera driver 440 controls operation of the image acquisition element of the camera module 441, and the image formation parts. Moreover, the camera driver 440 receives the output signal from the camera module 441, and generates and outputs the content file which contains the image of the to-be-photographed object as an output signal.

The internal memory unit 45 is equipped with an internal memory 451 and an internal memory interface (I/F) 450. The internal memory 451 is a non-volatile semiconductor memory, like flash memory for example, and the application programs, etc., which are used in the information processing device 2 are stored in the memory. In particular, the content file 60 imaged by the camera device 44 and the browsing list 62 transmitted from the image management device 1 are suitably stored in the internal memory 451 in this embodiment. The internal memory interface 450 controls the internal memory 451 when there is a read-out/write-in command of the data with respect to the internal memory 451. Also, read-out/write-in control of data is performed, and the read data are output by internal memory interface 450. In addition, a non-volatile memory card in which an installation or removal, like miniSD cards or microSD cards for example, is possible may be sufficient as the internal memory 451. In this case, the internal memory interface 450 is further equipped with a memory card slot for the memory card.

The mobile communication module 460 performs mobile radio communication with mobile communications networks through an antenna 464 based on the International Mobile Telecommunication-2000 (IMT-2000) specification, for example. That is, the mobile communication module 460 sounds an audio signal obtained by decoding the electromagnetic wave received from the base station of a mobile communication network from a speaker 463 through an audio interface 461. The audio which a microphone 462 collects through the audio interface 461 is encoded. The mobile communication module 460 transmits the encoded audio to the base station of a mobile communication network as an electromagnetic wave through the antenna 464. Moreover, the mobile communication module 460 is transmitting/receiving packeted data from the base stations of a mobile communication network, and performs data communications. At least one of the mobile communication specifications known to one of ordinary skill in the art is contained in the specification to which this mobile communication module 460 corresponds, for example, at least one of 3G/HSDPA (Third Generation/High-Speed Downlink Packet Access), LTE (Long Term Evolution), WiMAX (Worldwide Interoperability for Microwave Access) may be contained. Furthermore, as the specification to which the mobile communication module 460 corresponds, specifications currently under development and to be developed in the future may be applied suitably. Moreover, packeted data may be transmitted/received like VoLTE (Audio over Long Term Evolution) as data in which the audio is packeted.

The input-output device 47 is equipped with an input interface (I/F) 470, an input instruction unit 471, the touchscreen 472, and the USB interface 473.

The input instruction unit 471 is connected to the input interface 470, and the input signal input when a user operates the input instruction unit 471 is received. As the input instruction unit 471, the function button etc. which perform a setting input start movement directive etc., for example are mentioned. In this embodiment, the touchscreen 472 is superimposed by the upper surface of the display screen of the liquid crystal panel 431, is provided, and has a size substantially the same as the display screen of this liquid crystal panel 431. If the surface of the touchscreen 472 is touched by the user, namely, the specific position on the surface of the touchscreen 472 is touched by the user, the touchscreen 472 will detect the touch as a coordinate position, where the specific position on the surface of the touchscreen 472 is 2-dimensional. This coordinate position is output through the input interface 470.

The USB interface 473 is equipped with a USB connector, and performs read-out/writing of the data using the USB2.0 or USB3.0 specification with respect to the USB device 50 connected to the USB connector, directly or through a USB cable. A USB flash memory, a keyboard, etc., are examples of the USB device 50.

The wireless LAN interface 48 interfaces with the wireless access point 9 and performs wireless communication, for example, based on the IEEE 802.11 standard. This wireless LAN interface 48 can operate the information processing device 2 as a wireless LAN client.

Next, the functional structure of the information processing system in the first embodiment is described. FIG. 4 is a functional block diagram which shows the functional structure of the information processing system S of the first embodiment. In FIG. 4, the image management device 1 comprised by information processing system S of this embodiment is equipped with a control unit 70, a memory 71, a first input unit 72, an output unit 73, and a first communication unit 74.

The content file 60, the thumbnail file 61, and the browsing list 62 are stored in the memory 71. The content file 60 is contains content data 60a.

The thumbnail files 61 are the following files. When the resolution (vertical×horizontal pixel count, etc.) of content data 60a is reduced and content data 60a of the content file 60 is shown as display image 2a, 4a of the information processing device 2 and the display device 4, or when the content data 60a is JPEG (Joint Photographic Experts Group) data, it includes thumbnail data which is a reduced-size image of the appearance of the contents, using a higher compression rate, for example. Such a thumbnail file 61 is created due to the limitations of the resolution of display images 2a and 4a, and a reduction of the data transfer time between the image management device, the information processing device 2, and the display device 4, etc. Here, the thumbnail file 61 having a different resolution, etc., may be generated from the one content file 60. After content file 60 is stored in the image management device 1, the control unit 70 may start creation of the thumbnail file 61 automatically (or upon direction from a user), or when the image management device 1 is not operating for a long time, via background processing.

Hereinafter, when it is explained that content data 60a of the content file 60 is shown as display image 2a and 4a of the information processing device 2 and the display device 4, the case which shows the thumbnail data of the thumbnail file 61 relevant to this content file 60 shall also be included. Moreover, content data 60a or thumbnail data of the content file 60 or the thumbnail file 61 is shown on the display image 2a, 4a of the information processing device 2 and the display device 4. It may omit and explain as follows. The content file 60 is only shown on display images 2a, 4a.

The browsing list 62 is a list of the content file 60 used as the display subject by the information processing device 2 created by the browsing list creation unit 77 described below. The detail of the content file 60 and the browsing list 62 are described below.

The control unit 70 is equipped with an image capture unit 75, a first display control unit 76, a browsing list creation unit 77, and a content sending unit 78.

The image capture unit 75 detects a user's direction input or the connection of the information processing device 2 to the image management device 1, or the imaging device 3. The content file 60 is acquired from the information processing device 2 or the imaging device 3, and the acquired content file 60 is stored in the memory 71. Since the details of moving the content file 60 to the image management device 1 are already discussed above, the description here is omitted.

The first display control unit 76 outputs the data for display image generation for showing the content file 60 (content data 60a) stored in the memory 71 as the display image 4a of the display device 4. Preferably, the first display control unit 76 generates the data for display image generation for showing content files as one display image 4a of the display device 4 simultaneously. The display image 4a shown on the display device 4 with such data for display image generation that the first display control unit 76 generates, the display image is called a thumbnail display. In the thumbnail display, the content files are simultaneously represented in a predetermined smaller size by display image 4a.

Or, the first display control unit 76 may generate the data for display image generation for showing display image 4a in what is called a slide show display. A manner of the slide show display by the first display control unit 76 is arbitrary, for example, the content files may each be displayed for a predetermined time while switching from one to the next. Naturally, the first display control unit 76 is not limited to the slide show display mentioned above. A display similar to an album for sticking silver-halide photography, called a photo book, may be sufficient.

The browsing list creation unit 77 searches the content file 60 which becomes a display subject based on the browsing conditions input from the information processing device 2 based on a relevant information. The browsing list 62 of the content file 60 included in this searched result is created. The content sending unit 78 sends out the content file 60 to the information processing device 2 based on the browsing list 62 which the browsing list creation unit 77 created.

The differences with the first display control unit 76 and the content sending unit 78 are updated. The first display control unit 76 outputs the data for display image generation for showing the content file 60 stored in the memory 71 on display image 4a of the display device 4. On the other hand, the content sending unit 78 sends out the content file 60 to the information processing device 2 based on the browsing list 62 which the browsing list creation unit 77 created. That is, the first display control unit 76 outputs the data for display image generation for the display device 4 to show the content file 60 on the display image 4a. On the other hand, the content sending unit 78 sends the content file 60 to the information processing device 2.

The first input unit 72 receives the various input signals input into the image management device 1 from the external input equipment containing the input instruction unit 5, and it inputs the received input signal into the control unit 70. The first input unit 72 stores the input signals in the memory 71 via the control unit 70 as needed. The output unit 73 outputs the various data in the control unit 70 or the memory 71 containing the data for display image generation to the external output device containing the display device 4. The first communication unit 74 performs data communication between the external devices containing the information processing device 2, and transmits/receives the data containing the content file 60 and the browsing list 62.

Moreover, the information processing device 2 comprised in information processing system S of this embodiment is equipped with a control unit 80, a memory 81, a second input unit 82, a display unit 83, and a second communication unit 84. The content file 60 and the browsing list 62 which were transmitted from the image management device 1 are stored in the memory 81. The control unit 80 is equipped with a second display control unit 85 and a display image generation unit 86.

The display image generation unit 86 generates the data for display image generation for showing a display image on the display unit 83. The second display control unit 85 controls the display unit 83 based on the data for display image generation which the display image generation unit 86 generated to show display image 2a on a display screen.

Preferably, the display image generation unit 86 generates the data for display image generation for showing the images corresponding to the content files on a single display image 2a. The display image 2a shown on the display unit 83 with the data for display image generation which such a display image generation unit 86 generates, the display image is called a thumbnail display. Moreover, preferably, the display image generation unit 86 receives some content file 60 from the image management device 1, and generates the data for display image generation.

The second display control unit 85 controls the display unit 83 as follows. When a first operation input signal based on the operation input in a first direction on the display unit 83 is output from the second input unit 82, generation of the data for display image generation for showing the second display image, different from the first display image shown on the display screen, is directed in the display image generation unit 86. While the display image generation unit 86 is generating the data for display image generation for showing the second display image, a third display image which displays that the second display image is in generation is shown on a part of the display unit 83.

In more detail, when a user operates the display screen of the display unit 83 in the first direction and the second input unit 82 outputs the first operation input signal, the second display control unit 85 directs generation of the data for display image generation for showing the second display image, different from the first display image shown on the display screen, in the display image generation unit 86. And, while generating the data for display image generation for the display image generation unit 86 to show the second display image, the second display control unit 85 controls the display unit 83 to show the third display image which indicates that the second display image is in generation on a part of the display unit 83.

If a user can visually recognize that the second display image is in generation, arbitrary display modes can be used for the display mode of a third display image. For example, an hourglass which shows that it is in process is used in one known operating system (OS) with an animation which moves the hourglass in a clockwise rotation, a bar display extended to one direction which are called a progress bar, etc., are examples. Or, another display such as an advertising display, etc., may be performed with the display which shows that a second display image is in generation, Furthermore, it may be shown by performing an advertising display, etc., that a second display image is in generation. One such an example of a display is a web page which shows a specific advertisement. If the content files 60 are music data, the display type could show the cover art of an album, etc., is an example. The data for generating such a web page, etc., may be acquired at the time of displaying a third display image, or it may be regularly acquired during display operation of the content file 60 by the information processing device 2. Further, in the display image generation data for showing a second display image, the display image generation data which the display image generation unit 86 already generated is used. One content file 60 may be shown among the content files which comprise a second display image. Or, the data relevant to the first display image or the second display image may be shown. For example, if the content file 60 shown on the first or second display image is generated at a specific season, data relevant to this specific season could be shown. For example, image data which symbolizes summer if it is summer.

It is preferable that the second display control unit 85 stops the display of the third display image being in generation here, if generation of the data for display image generation for the display image generation unit 86 to show the second display image is completed. Furthermore, when a web page, image data, etc., are being shown, it may be shown until the display of these web data finishes to the end.

Preferably based on the continuous movement operation input of the certain distance in the first direction on a display screen, the second input unit 82 generates and outputs the first operation input signal mentioned above. Such a continuous movement operation input of the certain distance in the first direction on a display screen is based on the operation input which is called a swipe, which a user makes over a certain distance continuously on the display unit 83 in one direction which is the first direction, for example.

It is preferable that the display image generation unit 86 generates the first display image and the second display image based on a predetermined permutation. As the permutation at the time of the display image generation unit 86 generating the first display image and the second display image, when several images are shown on a first and second single display image, for example, the content file 60 corresponding to the image included in each first and second display image is equipped with tag data (described below for details) of a predetermined range, and the tag data in this predetermined range make the predetermined permutation. The tag data of this predetermined range are correspond to the browsing conditions at the time of creating the browsing list 62 described above. In other words, it is preferable that the first and second display images are generated based on different browsing conditions.

In more detail, the image of several content files 60 imaged in a predetermined month is shown on the first display image, and the image of several content files 60 imaged in the month after the month corresponding to the first display image is shown in the second display image. The first display image and the second display image form the permutations along a month. The display image generation unit 86 generates the first display image and the second display image based on the permutation of a “month.”

Naturally, the permutation is not limited to months. Based on a permutation which followed in time series, the first display image and the second display image may be generated in a wider range, for example. Or, the time series may be based on irregular phenomena, such as a timing when the content file 60 was acquired by the image management device 1.

Furthermore, when the content file 60 is classified into several groups by the user, the “permutation” may be based on the fixed rule set by the grouping by the user.

Moreover, as for the display image generation unit 86, multiple types of display image may be generated, including more than two types of display images called a first display image and a second display image. In this case, two types of display images are selected along this permutation, and are set as the first and second display images out of the three or more types of display images arranged in a predetermined permutation.

More preferably, the first direction in the continuous movement operation input of the certain distance in the first direction on a display screen made by the user for producing a first operation input signal, and the direction of permutation for changing to the second display image from the first display image are made to correspond. For example, it is preferable to vary the transition direction of permutation in the case where the first direction is a movement operation input in a rightward direction on the display screen, and in the case where the first direction is a movement operation input in a leftward direction on the display screen.

And, while generating the data for display image generation for the display image generation unit 86 to show the second display image, it is preferable that the second display control unit 85 controls the display unit 83 as follows. While moving the first display image in the first direction by a predetermined distance, in connection with the first display image moving, a third display image is shown on the area which remains on the display screen. The area of the display unit 83 where the third display image is shown is an area where a part of first display image has moved from the display screen in connection with the first display image moving. Therefore, at this time, the area of the first display image which has left the display screen is excluded in the displayed image of the display unit 83, namely, the remaining part of the first display image and the third display image are simultaneously shown on the display unit 83.

Here, it is preferable that the certain distance in which the continuous movement operation input in the first direction on the display screen is performed is shorter than the predetermined distance by which the second display control unit 85 moves a first display image in the first direction. More preferably, the certain distance is more than half of the predetermined distance, and is shorter by a predetermined distance. When the certain distance is less than half of the predetermined distance, it is preferable that the second display control unit 85 does not move the first display image in the first direction only by a predetermined distance. Furthermore, it is preferable not to direct generation of the data for display image generation for showing the first display image shown on the display screen, or to direct generation of the data for display image generation for showing the second display image by the display image generation unit 86.

While generating the data for display image generation for the display image generation unit 86 to show a second display image, it is preferable that the second display control unit 85 controls the display unit 83 as follows. A third display image is superimposed and shown on a part of the first display image, without making the first display image move in the first direction only by a predetermined distance, and making the first display image partly covered by the third display image.

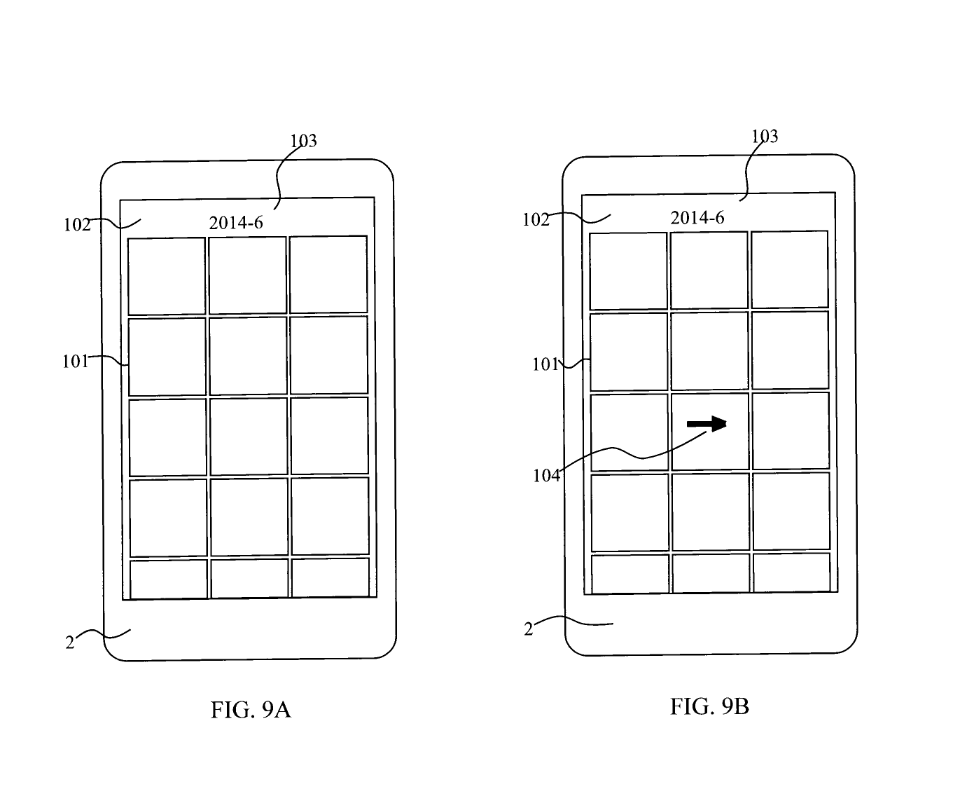

Moreover, when completing generation of the data for display image generation for the display image generation unit 86 to show the second display image, preferably the second display control unit 85 controls the display unit 83 to move the first display image in the first direction, to make the first display image leave from the display screen, and to show the second display image on the display screen. In this case, the timing for which the second display image is displayed on the display screen is, after completing generation of the data for display image generation for showing a display image with the second display image generation unit 86, for example, on the condition that generation of the data for display image generation for the display image generation unit 86 to show a second display image was completed, after operation input in the first direction is performed, and after a predetermined time passes the second display image may be shown on a display screen. Or, as long generation of the data for display image generation of the second display image is completed, which can (for example, 3 rows×4 lines in the thumbnail file 61 in an example shown in FIG. 9A and FIG. 9B) be shown on the display screen of the information processing device 2 in one image, a second display image may be shown on a display screen.

More preferably, while generating the data for display image generation for the display image generation unit 86 to show the second display image, if the second operation input signal based on the operation input in the second direction, different from the first direction on the display screen, is output from the input unit, the second display control unit 85 controls the display unit 83 as follows. The generation of the data for display image generation for showing the second display image by the display image generation unit 86 is interrupted. Furthermore, the first display image is again displayed by moving the first display image only by a predetermined distance in an opposite direction to the first direction. Here, it is preferable that the second direction is in the opposite direction of the first direction. Preferably, the content file 60 acquired for the second display image generation is stored in a cache area provided in the memory 81, and generation of the data for display image generation for showing a second display image is performed quickly. Furthermore, it is more preferable to store preferentially the content files, etc., which are shown in the second display image which may be changed from the first display image in a cache area based on the permutation mentioned above.

Or, while generating the data for display image generation for the display image generation unit 86 to show the second display image, if the operation input signal based on the operation input on the display screen corresponding to the third display image is output from the input unit, the second display control unit 85 controls the display unit 83 as follows. The generation of the data for display image generation for showing the second display image by the display image generation unit 86 is interrupted. Furthermore, the first display image is again displayed over the entirety of the display screen by moving the first display image only by a predetermined distance in the opposite direction to the first direction.

As an aspect of the operation input on the display screen corresponding to the third display image for interrupting generation of the data for display image generation for showing the second display image by the display image generation unit 86, various choices could be made by one of ordinary skill in the art. For example, the display image generation unit 86 could show a Cancel button in the third display image. If the second input unit 82 detects that this Cancel button was touched by the user, the second display control unit 85 determines that the operation input on the display screen corresponds to the third display image for interrupting generation of the data for display image generation for showing the second display image by the display image generation unit 86.

Furthermore, it is preferable to control the display unit 83 to show information for the second display control unit 85 to identify the second display image on the third display image. As the information for identifying a second display image, a character string which showed the browsing conditions for generating the second display image, and a part of the image data corresponding to the content file 60 shown on the second display image are examples.

The second input unit 82 generates an operation input signal corresponding to the operation input on the display screen of the display unit 83 by a user, and outputs this operation input signal. The display unit 83 shows display image 2a on a display screen based on the data for display image generation which the display image generation unit 86 of the control unit 80 generated. The second communication unit 84 performs data communication between external devices containing the image management device 1, and transmits/receives the data containing an operation input signal.

In the above structure, the image capture unit 75, which is included in the control unit 70, the first display control unit 76, the browsing list creation unit 77, and the content sending unit 78 are mainly comprised by the CPU 20. The memory unit 71 is mainly comprised by the memory card 7, ROM 21, RAM 22, and the HDD unit 26. The first input unit 72 is mainly comprised by the input-output device 23, the network interface 25, and the wireless LAN interface 27. The output unit 73 is mainly comprised by the HDMI interface 24. The first communication unit 74 is mainly comprised by the network interface 25 and the wireless LAN interface 27. Moreover, the control unit 80, the second display control unit 85 which is included in the control unit 80, and the display image generation unit 86 are mainly comprised by CPU 40. The memory 81 is mainly comprised by ROM 41, RAM 42, and the internal memory unit 45. The second input unit 82 is mainly comprised by the input-output device 47. The display unit 83 is mainly comprised by the display device 43. The second communication unit 84 is mainly comprised by the wireless LAN interface 48. The operation of each functional part shown in FIG. 4 is explained in full detail above.

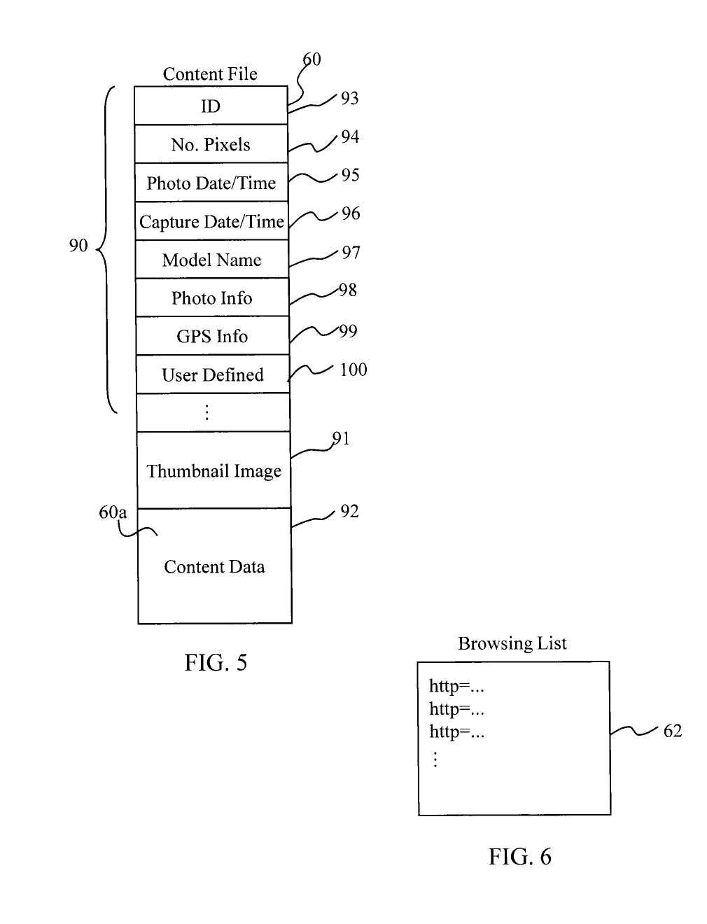

Next, data structure of a content file is discussed. FIG. 5 is a figure which shows an example of the data structure of the content file 60 stored in HDD 261 of the image management device 1 of this embodiment. The content file 60 of this embodiment has a file format defined by the Exif (Exchangeable image file format) specification. Tag data are stored in the header 90. Furthermore, the thumbnail area 91 where thumbnail image data is stored, and the content data area 92 where content data 60a is stored are provided. In the content file 60 of this embodiment, the tag data stored in the header 90 are described by the predetermined area of the header 90 of the content file 60 with the information processing device 2 and the imaging device 3 at the time of the to-be-photographed object's imaging, for example.

The header 90 of the content file 60 is provided with the following. An ID area 93 stores a unique value (ID) for identifying the content file 60, and a pixel count area 94 stores the pixel count of content data 60a. An image date and time area 95 stores the imaging date and time data of the content file 60, and a capture date and time area 96 stores the capture date and time to the image management device 1 of the content file 60. A model name area 97 stores the model name of the information processing device 2 with which the content file 60 was imaged and the imaging device 3 is described, as well as a variety of information about the information processing device 2 at the time of content data 60a of the content file 60 being imaged, and about the imaging device 3, for example, an aperture value and shutter speed. The imaging information area 98 stores a focal length used by the imaging device 3 to capture the content data 60a. The GPS information area 99 stores the positional information (for example, the latitude, the longitude, and elevation information) at which the information processing device 2 and the imaging device 3 were located when the content file 60 was imaged, i.e., an imaging position, by a Global Positioning System (GPS). The user definition area 100 for the user of the image management device 1 may store a variety of arbitrary, user-defined information. Naturally, other areas may also be provided in the header 90 of the content file 60.

Here, an example and explanation is given regarding the various tag data described by each area of the header part 90. In the image date and time area 95, it refers to the internal time of the information processing device 2 and the imaging device 3, and the date and time when content data 60a of the content file 60 was generated. That is, the imaging time data which show the imaged date and time are described, for example, as “2013/06/01 10:15:24”, i.e., a date and a time to units of a second. The capture date and time area 96 refers to the internal time of the image management device 1, that is, the date and time when content data 60a of the content file 60 was acquired in the image management device 1. For example, the capture date and time are described as “2013/06/28 18:00:58”, i.e., a date and a time to units of a second. The model name of the information processing device 2 and the imaging device 3 is described as “XYZ”, for example, in the model name area 97 by a manufacturer-defined string. The variety of information of the information processing device 2 and the imaging device 3 at the time of content data 60a of the content file 60 being captured is described, for example, as “aperture value F/8 and shutter speed 1/125” in the photographing information area 98. The GPS information area 99 stores data which shows the positional information obtained by using a GPS system for the position at which the information processing device 2 and the imaging device 3 were located when the content file 60 was generated. The latitude information, longitude information, and elevation information of the position which the information processing device 2, etc., may be described, for example, as “lat=+35.09.36.266, lon=+136.54.21.114, alt=50”.

Next, a content of the browsing list is described. FIG. 6 is a figure showing an example of the contents of the browsing list 62 stored in HDD 261 of the image management device 1 in the present embodiment. The browsing list 62 is a list of the data in which may be requested from the information processing device 2 for each of the content files 60 corresponded to the browsing conditions described. For example, it is a list of the paths on the network of the applicable content files 60 in the information processing system S, such as URLs, etc.

Based on the browsing conditions input from the information processing device 2, the browsing list creation unit 77 creates the browsing list 62. The detail of the creation procedure of the browsing list 62 is described below.

Next, an outline of the operation of the information processing system in the first embodiment is given. With reference to FIGS. 9-11, the outline of the operation of the information processing system S of this embodiment is explained centering around the transition of display image 2a, especially shown on the display unit 83 of the information processing device 2.

When a user inputs the browsing conditions of the content file 60 through the second input unit 82 of the information processing device 2, the input browsing conditions will be transmitted to the image management device 1 through the second communication unit 84. The browsing list creation unit 77 of the image management device 1 creates the browsing list 62 in which the path of the content files 60 corresponding to the transmitted browsing conditions, URL, etc. are described. The created browsing list 62 is transmitted to the information processing device 2 through the first communication unit 74.

The second display control unit 85 of the information processing device 2 is as follows. Based on the transmitted browsing list 62, the resolution of the display screen of the display unit 83, etc., are considered. The path corresponding to the content file 60 which can be shown on a single display screen among the content files 60 corresponding to the list described by the browsing list 62, URL, etc., are transmitted to the image management device 1. Sending of the content file 60 corresponding to these paths is requested of the image management device 1.

The content sending unit 78 of the image management device 1 sends out the content file 60 including the thumbnail file 61 corresponding to a path, etc., to the information processing device 2 based on the path, etc., which were transmitted from the information processing device 2. The second display control unit 85 of the information processing device 2 controls the display unit 83 as follows. Based on the sent content file 60, generation of the display image for showing these content files 60 on the display of the display unit 83 is directed in the display image generation unit 86. The display image generation unit 86 generates the data for display image generation based on the direction from the second display control unit 85. The second display control unit 85 generates a display image for the display screen of the display unit 83 based on the data for display image generation which the display image generation unit 86 generated.

FIG. 9A shows the first display image 102 which has the image data 101 of several content files 60 (including thumbnail files 61) shown on the display screen of the display unit 83 of the information processing device 2. In the example shown in FIG. 9A, the user has input browsing conditions on the image date and time which browses the content file 60 for content which is in June 2014. The display image generation unit 86 also shows the character string 103 which shows this browsing condition in display image 2a. Therefore, the first display image 102 in the present example contains the image data 101 and the character string 103.

In this state, a user looks at the first display image 102 in an example of a first direction from an upward direction (usually from the user's side), when the continuous movement operation input of the certain distance of a substantially horizontal direction is performed rightward from the left (as shown by the arrow 104 in FIG. 9B). The second input unit 82 of the information processing device 2 outputs a first operation input signal according to this movement operation input. It is preferable that the certain distance is shorter than the predetermined distance which a first display image moves by the second display control unit 85, as described above.

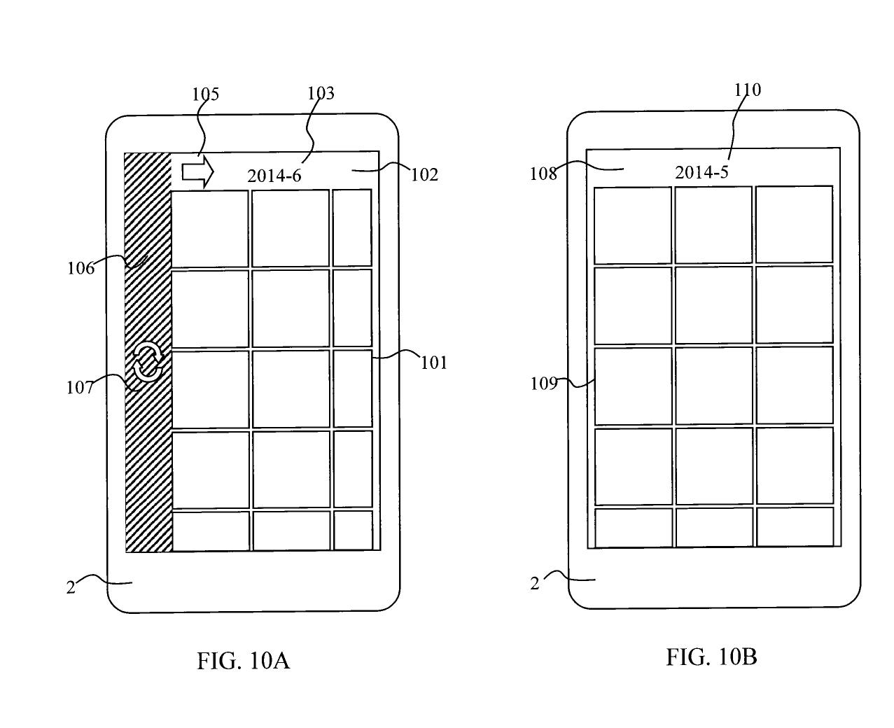

According to the operation input in the first direction shown by the arrow 104 of FIG. 9B, as shown in FIG. 10A, the second display control unit 85 moves the first display image 102, the image data 101 contained in this, and the character string 103 only by a predetermined distance in the first direction (in the example in a rightward direction), as shown by the arrow 105. And in connection with the first display image 102 having moved only by a predetermined distance, a part of the first display image leaves from the display screen of the information processing device 2. An area of the display screen, which is the area uncovered by the movement of the first display image 102, now displays the third display image 106 (indicated by hatching in FIG. 10A). The second display control unit 85 generates this display, which shows that the second display image is in generation, including the third display image 106. In the example of the embodiment, the second display control unit 85 is moving the arrow 107 arranged on a circular arc in a clockwise manner, and exhibits a display which shows that the second display image is in generation.

If generation of the data for display image generation for showing the second display image by the display image generation unit 86 is completed, the first display image 102 is made to leave the display screen by the second display control unit 85, moving the first display image 102 in the first direction, as shown in FIG. 10B. The second display image 108 is now displayed on the display screen. In the example of the present embodiment, the second display image 108 contains character string 110, which shows May 2014, which image date and time is the image data 109 and the browsing condition of the content file 60 which is May 2014.

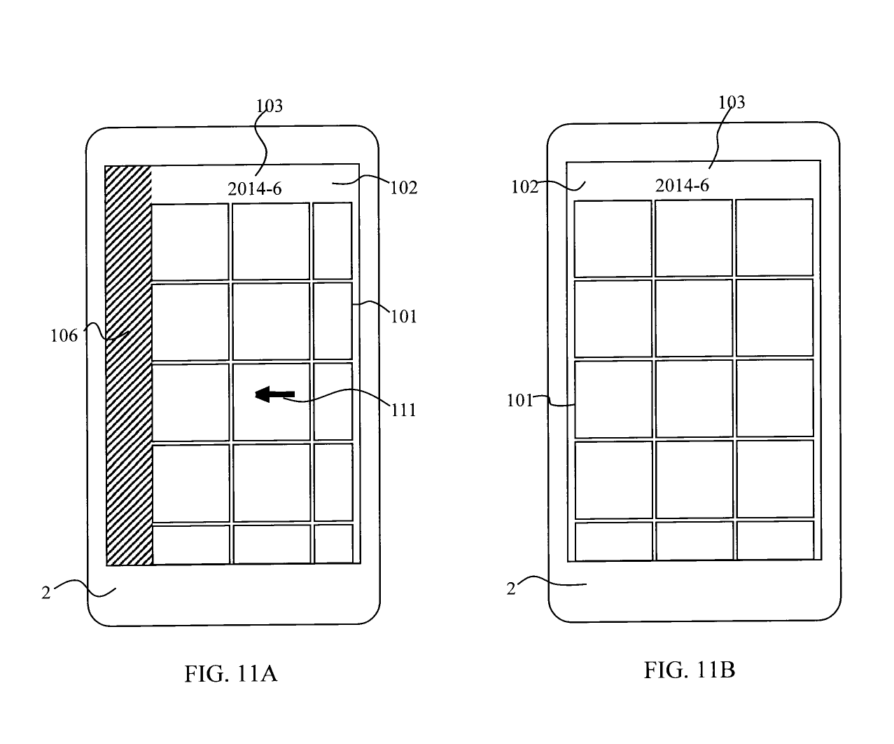

On the other hand, while generating the data for display image generation for the display image generation unit 86 to show the second display image 108, a user looks at the first display image 102 in an example of a second direction, from the upward direction and different from the first direction, when the continuous movement operation input of the certain distance in a substantially horizontal direction is performed in a right-to-left direction (as shown by the arrow 111 in FIG. 11A). The second input unit 82 of the information processing device 2 outputs a second operation input signal according to this movement operation input. In the example of the embodiment, the first direction and the second direction are opposite directions.

According to the operation input in the second direction as shown by the arrow 111 of FIG. 11A, the second display control unit 85 interrupts the generation of the data for display image generation for showing the second display image by the display image generation unit 86. Furthermore, the display unit 83 is controlled to move the first display image 102 in the direction opposite to the first direction, i.e., in the second direction, by the predetermined distance to display the full first display image 102 again. As a result, as shown in FIG. 11B, the first display image 102 is again fully shown on the display screen.

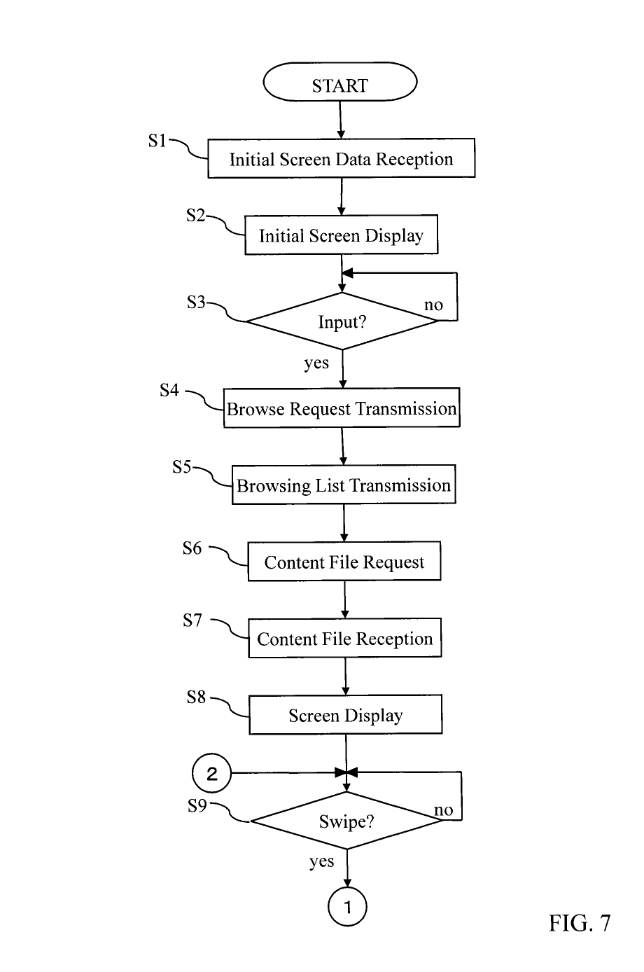

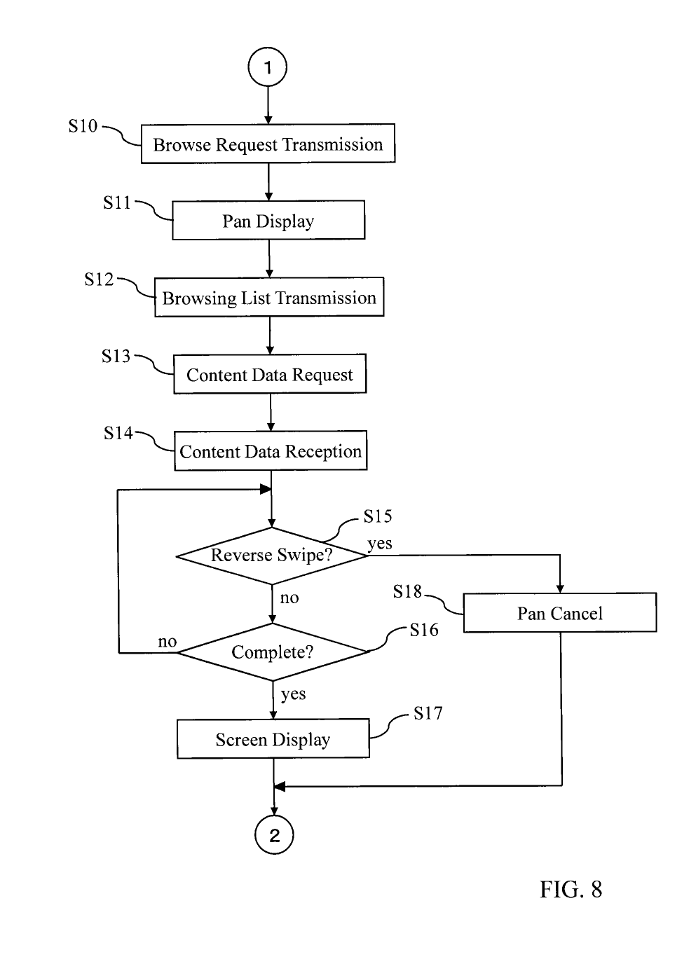

Next, with reference to the flowchart of FIG. 7 and FIG. 8, the operation of the information processing device 2 which is comprised by information processing system S of this embodiment is explained. FIG. 7 and FIG. 8 provide a flowchart for explaining the operation which browses the content file 60 stored in the image management device 1 which comprises information processing system S of this embodiment with the information processing device 2.

The flowchart shown in FIG. 7 is started by the operation of starting the application for browsing the content file 60 in the information processing device 2. First, in step S1, the first display control unit 76 of the image management device 1 generates the data for display image generation for showing an initial display image 2a of the information processing device 2. This data for display image generation is transmitted to the information processing device 2 through the first communication unit 74. The data for display image generation transmitted from the image management device 1 is received by the second communication unit 84 of the information processing device 2. In step S2, based on the data for display image generation received in step S1, the second display control unit 85 of the information processing device 2 controls the display unit 83 to show an initial display image 2a.

In step S3, the browsing conditions for the second input unit 82 of the information processing device 2 to generate the first display image by a user are waited for. When the browsing conditions for a user to generate a first input image are input (in step S3 YES), in step S4, the second display control unit 85 transmits the browsing request of the content file 60 to the image management device 1 with the browsing conditions input by the user.

When the first communication unit 74 of the image management device 1 receives the browsing request from the information processing device 2, the browsing list creation unit 77 will search the content file 60 stored in the memory 71 based on the received browsing conditions, The content files 60 corresponding to this browsing condition are extracted, and based on the extraction result, the browsing list 62 of the content file 60 corresponded on browsing conditions is created.

In step S5, the browsing list creation unit 77 of the image management device 1 transmits the browsing list 62 through the first communication unit 74. The second display control unit 85 of the information processing device 2 receives the browsing list 62 transmitted from the image management device 1 through the second communication unit 84. In step S6, the second display control unit 85 of the information processing device 2 transmits the transmission request for a content file 60 (the thumbnail file 61 may be used) shown by a first display image to the image management device 1 based on the aspect which shows the content file 60 in the display unit 83. In step S7, the content sending unit 78 transmits the content file 60 which had a transmission request based on the transmission request of the content file 60 transmitted from the information processing device 2 through the first communication unit 74. The second display control unit 85 of the information processing device 2 receives the content file 60 transmitted from the image management device 1 through the second communication unit 84. In step S8, the second display control unit 85 directs generation of the data for display image generation for showing the first display image in the display image generation unit 86 based on the content file 60 transmitted from the image management device 1. If the data for display image generation for the display image generation unit 86 to show a first display image is generated, the display unit 83 will be controlled to show the first display image based on this data for display image generation.

About the specific content of the mode in which the content file 60 is shown in the display unit 83, various methods, such as a thumbnail display, a slide show display, etc., which have already been described above are possible. Therefore, a detailed description is omitted here. The display mode of the content file 60 in the display unit 83 can be suitably set by a user. In the set display mode, the second display control unit 85 determines which (they are sometimes several) content file 60 is required with reference to the browsing list 62. The transmission request of the content file 60 to be shown is transmitted using information, such as a path described in the browsing list 62.

Next, in step S9, the second input unit 82 waits until the continuous movement operation input of the certain distance in the first direction on the display screen of the display unit 83 is completed by the user. When the continuous movement operation input of the certain distance in the first direction is completed by the user (in step S9 YES), a first operation input signal will be output based on this movement operation input. In step S10, the second input unit 82 responds to having output the first operation input signal, and browsing conditions for the second display control unit 85 to generate a second display image are computed. With the computed browsing conditions, the browsing request for the content file 60 is transmitted to the image management device 1.

Since the operation to step S10 and step S12 to S14 is the same as the operation to step S4 to S7 mentioned above, a detailed description of these steps is omitted.

On the other hand, in step S11, the second display control unit 85 directs generation of the data for display image generation for showing a second display image with respect to the display image generation unit 86. Furthermore, the first display image is moved in the first direction only by a predetermined distance. Also, a third display image is displayed on a part of display screen which is the area where a part of first display image left from the display screen in connection with this first display image having moved only by a predetermined distance. The second display control unit 85 produces a display which shows that a second display image is in generation in the third display area.

In step S15, it is determined whether the movement operation input of the certain distance in a second direction different from first direction with the continuous second input unit 82 was performed by the user. If it is determined that the continuous movement operation input of the certain distance in the second direction has been performed by the user (in step S15 YES), the algorithm proceeds to step S18. On the other hand, if it is determined that a continuous movement operation input of the certain distance in the second direction not been performed by the user at this time (in step S15 NO), the algorithm will proceed to step S16. It is determined whether the generation of the data for display image generation for the display image generation unit 86 to show the second display image was completed. If it is determined that the generation of the data for display image generation for the display image generation unit 86 to show a second display image is complete (in step S16 YES), the algorithm will proceed to step S17. If it is determined that the generation of the data for display image generation for the display image generation unit 86 to show a second display image is not complete (in step S16 NO), the algorithm will return to step S15.

In step S17, the second display control unit 85 directs generation of the data for display image generation for showing the second display image in the display image generation unit 86 based on the content file 60 transmitted from the image management device 1. If the data for display image generation for the display image generation unit 86 to show a second display image is generated, the display unit 83 will be controlled to show the second display image based on this data for display image generation.

On the other hand, if the second input unit 82 of the information processing device 2 outputs a second operation input signal according to the movement operation input, the algorithm proceeds to step S18. The second display control unit 85 responds to the second input unit 82 having output the second operation input signal, and it interrupts generation of the data for display image generation for showing the second display image by the display image generation unit 86. Furthermore, the display unit 83 is controlled by moving a first display image only by a predetermined distance in the opposite direction to first direction to fully display the first display image again.

With information processing system S of the first embodiment, if the first operation input signal based on the operation input in the first direction on a display screen is output from the second input unit 82, the second display control unit 85 controls the display unit 83 as follows. Generation of the data for display image generation for showing the second display image on the display image generation unit 86 is directed. While generating the data for display image generation for the display image generation unit 86 to show a second display image, the third display image which shows that a second display image is in generation is shown on a part of display screen of the display unit 83. Therefore, the user can visually recognize easily that it is during generation of the data for display image generation for the display image generation unit 86 to show a second display image, while the third display image is shown. Thereby, the information processing device, the information processing system, and the display control method and program for an information processing device which can perform display control which, as much as possible, does not impair the usability in the case of image switching are realizable.

Next, we describe a second embodiment of the present disclosure. In the first embodiment described above, the image management device 1 was equipped with the memory 71, and the content file 60 was stored in this memory 71. However, the image management device 1 does not need to store the content file 60 internally. The content file 60 can also be provided in a storage device separate from the image management device 1, where the image management device 1 accepts at least a part of the content file 60 from this storage device.

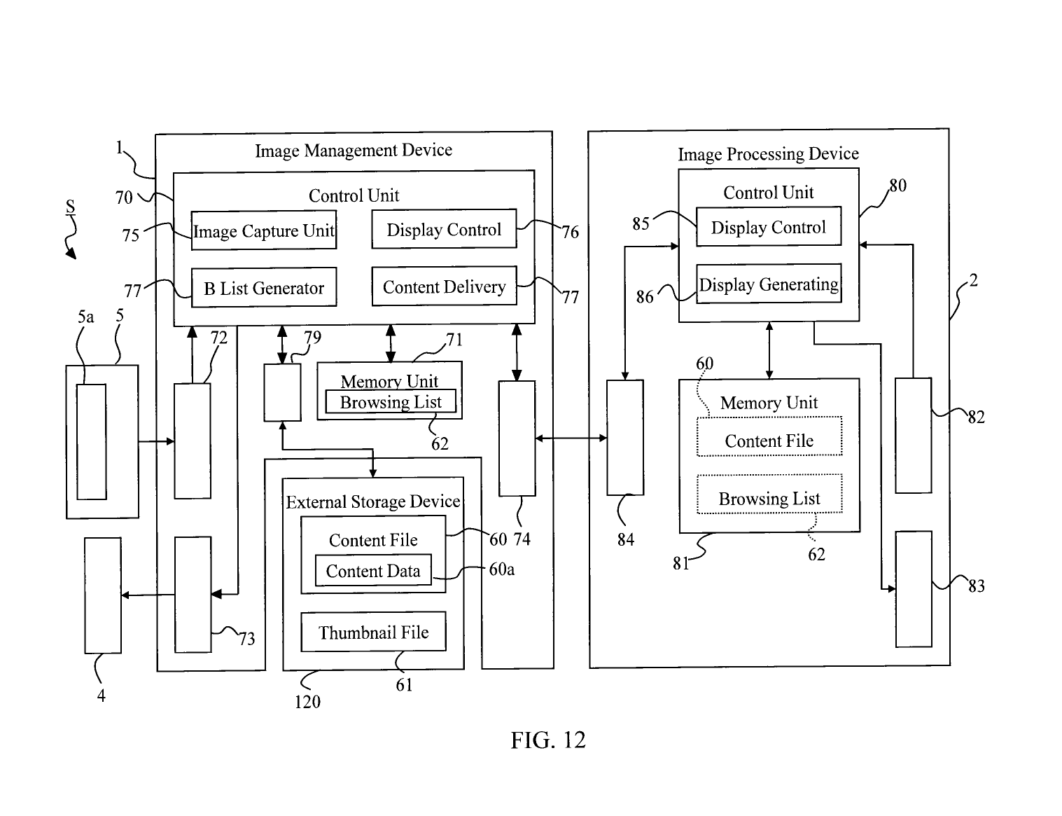

FIG. 12 is a functional block diagram which shows the functional structure of an information processing system S which is a second embodiment of the disclosure.

In FIG. 12, an external storage device 120 is connected to the image management device 1 of this embodiment. The content file 60 and the thumbnail file 61, similar to first embodiment, are stored in the external storage device 120. The external storage device 120 may be, for example, an external HDD device, a USB flash memory device, a memory card 7, etc., for example. If the connection between the image management device 1 and the external storage device 120 is a form which passes data between the image management device 1 and the external storage device 120, and which can transmit the content file 60 and the thumbnail file 61, there will be no special limitation. The connection may be through a cable, through electromagnetic waves, such as in a wireless LAN, or a form which inserts the memory card 7 in the card interface 232 (see FIG. 2) of the image management device 1. Any such connection known to one of ordinary skill in the art is employable.

Moreover, the image management device 1 of this embodiment is further equipped with an input-output unit 79, as compared with the image management device 1 of the first embodiment discussed above. The input-output unit 79 controls the transmission and reception of the data between the external storage device 120 and the image management device 1. Moreover, the browsing list 62 is stored in the memory 71 of this embodiment. Moreover, in the following description, the same reference numerals are given to components similar to those in the above-mentioned first embodiment, and the description of the second embodiment is simplified but not repeating the description of those components.

Therefore, an effect similar to the above-mentioned first embodiment can be obtained also in the second embodiment. In particular, according to this embodiment, it is possible to separate the image management device 1 and the external storage device 120 into different components. For example, it is also possible to comprise the external storage device 120 by an external server 14 (see FIG. 1) which exists on WAN 13. Thus, the simplification of a structure of the image management device 1 as a whole can be attained.

In addition, as for the information processing device, the information processing system, and the display control method and program in information processing device of this disclosure, the details are not limited to the above-mentioned embodiments. Various modified examples are possible.

For example, the touchscreen 470 of the information processing device 2 is superimposed and provided in the display screen of the liquid crystal panel 431 by the above-mentioned embodiments. Thereby, the second input unit 82 was outputting the operation input signal based on the operation input on the display screen of the display unit 83. However, a structure which provides the second input unit 82 and the display unit 83 in separate components is also possible. For example, the touchscreen 470 can be provided in a different place from the liquid crystal panel 431 (for example, on a frame portion of the liquid crystal panel 431, i.e., a bezel or border). An operation input signal may be output based on the operation input in the operation surface on this touchscreen 470. Naturally, the touchscreen 470 may be provided in two or more components, and one may be superimposed and provided in the display screen of the liquid crystal panel 431, and one may be provided in the frame part (bezel part) of the liquid crystal panel 431. Furthermore, this disclosure is applicable also to a head mounted display which detects the operation of a user's hand, etc., and in which operation input is possible, like Google Glass®. In this case, based on the operation input on the virtual operation surface provided in a user's visual field, an operation unit outputs an operation input signal. Moreover, a display screen is projected into a user's visual field.

Moreover, in each of the embodiments discussed above, although the third display image 106 was displayed on the area which a part of the first display image 102 left on the display screen by moving the first display image 102 in the first direction only by a predetermined distance (see FIG. 11), the third display image may also be superimposed and shown on a part of the first display image, without making it move in the first direction only by a predetermined distance, and making a first display image leave space for it.

Moreover, in each of the embodiments discussed above, the transition direction of the first display image and the second display image generated by the operation input in the first direction or the second direction on the display screen was performed based on a predetermined permutation. However, by an operation input in a third direction, different from both the first direction and the second direction, the transition direction of the display in the third display image may be generated based on a different permutation from the display image. In the example shown in FIGS. 9-11, for example, the first display image and the second display image were generated based on the permutation of a monthly unit (2014 May, June). However, the third display image based on the operation input in the third direction may be generated based on the permutation of a year unit (2013, 2014 June).

Moreover, the operation input in the second direction for directing discontinuation of generation of the data for display image generation for showing the second display image by the display image generation unit 86 does not need to be the first direction and in the opposite direction. If it is in a different direction, there will be no limitation in the direction. When the first direction is a horizontal direction (see FIG. 10) from the left of a display screen to the right, for example, the direction orthogonal to this first direction, for example, an upward direction and a downward direction, may be sufficient as second direction. Furthermore, when the third direction mentioned above is made into the upward direction and the downward direction in this example, while directing discontinuation of generation of the data for display image generation for showing the second display image by the operation input in a third direction, the transition direction of the display in the third display image generated based on different permutation from a display image may be performed.

Moreover, in the each of the embodiments discussed above, the transition direction of the display to a first second display image from a display image was performed based on the continuous movement operation input of the certain distance in the first direction on a display screen. However, according to the distance of the movement operation input in the first direction on the display screen, the transition direction of the display to the display image generated based on a different permutation may be performed. When there exists a movement operation input longer than the above-mentioned certain distance, for example, a display image is generated based on the permutation of two monthly units (2014 April, June). Furthermore, when there exists for a certain distance a sufficiently longer movement operation input, a display image may be generated based on the permutation of a year unit (2013, 2014 June).

And in the each of the embodiments described above, the program which operates the image management device 1 and the information processing device 2 was provided by storing in ROMs 21 and 41, the HDD section 46, etc. However, an optical disk drive, the USB interfaces 233 and 473, etc., and other devices which are not shown. A DVD (Digital Versatile Disc), USB flash memory device, the memory card 7, etc., in which the program is stored can also be connected. From the DVD, etc., a program may be read into the image management device 1 and the information processing device 2, and may be executed thereon. Moreover, the program may be stored in the external server 14 on WAN 13, and through the network interface 25 and the wireless LAN interfaces 27 and 48, this program may be read into the image management device 1 and the information processing device 2, and may be executed thereon. Furthermore, in the each of the embodiments described above, the image management device 1 and the information processing device 2 comprised several hardware elements. However, it is also possible to achieve operation of some these hardware elements by operation of a program by CPU 20 and CPU 40. In addition, the HDD device 26 was used in each of the embodiments discussed above. However, it is also possible to use storage media (the known storage media, for example, such as a SSD (Solid State Drive) device and memory card) other than the HDD device 26.

We claim:

1. An information processing device comprising:
circuitry configured to:
generate first image data for a first image to be displayed on a display screen of a display;
cause the display to display the first image on the display screen;
receive an input signal in response to a swipe input having a direction;
generate second image data for a second image to be displayed on the display screen in response to the received input signal; and
cause the display to display a third image on a portion of the display screen, the portion of the display screen being on a side of the display screen opposite the direction of the swipe input, while the display is generating the second image data to be displayed on the display screen.

2. The information processing device according to claim 1,
wherein the circuitry is configured to receive the input signal in response to the swipe input from on or above a surface of the display.

3. The information processing device according to claim 1,
wherein the circuitry is configured to receive the input signal in response to the swipe input on or above an operation surface different from a surface of the display, or in response to the swipe input by a gesture in front of an image recognition device.

4. The information processing device according to claim 1,
wherein the portion of the display screen includes an entire side of the display screen.

5. The information processing device according to claim 1,
wherein an area corresponding to the third image portion of the display screen is increased in proportion to a length of the swipe input.

6. The information processing device according to claim 1, wherein
the swipe input is a first swipe input and the direction is a first direction, and
the circuitry is further configured to cause the display to stop displaying the second image in response to a second swipe input having a second direction, the second direction being an opposite direction to the first direction.

7. The information processing device according to claim 6,
wherein the circuitry is configured to cause the display to stop displaying the third image in response to the second swipe input only in a case that the circuitry receives an input signal corresponding to the second swipe input within a predetermined time from a time when the circuitry receives an input signal corresponding to the first swipe input.

8. The information processing device according to claim 6,
wherein the circuitry is further configured to cause the display to stop displaying the third image in response to the second swipe input, and redisplay the first image on an entirety of the display screen.

9. The information processing device according to claim 1, wherein
the portion of the display screen is a first portion of the display screen,
the circuitry is further configured to generate fourth image data for a fourth image to be displayed on the display screen in response to a swipe input having a third direction, the third direction being different from the direction and a direction opposite to the direction, and
the circuitry is further configured to cause the display to display a fifth image on a second portion of the display screen, the second portion of the display screen being on a side of the display screen opposite the third direction, while the display is generating the fourth image data.

10. The information processing device according to claim 9, wherein
the circuitry is further configured to stop generating the fourth image data in response to a swipe input in a fourth direction on the input device, the fourth direction being an opposite direction to the third direction, and
the circuitry is further configured to cause the display to stop displaying the fifth image in response to the swipe input in the fourth direction, and redisplay the first image on an entirety of the display screen.

11. The information processing device according to claim 1,
wherein the third image indicates that the circuitry is generating the second image data.

12. The information processing device according to claim 1,
wherein the information processing device further comprises the display.

13. The information processing device according to claim 1,
wherein the circuitry is configured to cause the display to display the second image on an entirety of the display screen and stop displaying the third image in a case that the circuitry determines the generating of the second image data is complete.

14. The information processing device according to claim 1,
wherein the first image data and the second image data are stored on a server.

15. An information processing method comprising:
generating first image data for a first image to be displayed on a display screen of a display;
causing the display to display the first image on the display screen;
receiving an input signal in response to a swipe input having a direction;
generating second image data for a second image to be displayed on the display screen in response to the received input signal; and
causing, using circuitry, the display to display a third image on a portion of the display screen, the portion of the display screen being on a side of the display screen opposite the direction of the swipe input, during the generating of the second image data to be displayed on the display screen.

16. The information processing method according to claim 15, further comprising:
receiving a second swipe input having a second direction; and
ceasing generating the second image data in response to the receiving of the second swipe input; wherein
the swipe input is a first swipe input and the direction is a first direction, and
the second direction is an opposite direction to the first direction.

17. The information processing method according to claim 15, further comprising:
receiving a third swipe input having a third direction;
generating fourth image data in response to the third swipe input; and
displaying a fifth image on a second portion of the display screen, the second portion of the display screen being on a side of the display screen opposite the third direction, during the generating of fourth image data, wherein
the direction is a first direction, and
the third direction is different from the first direction and a direction opposite to the first direction.

18. A non-transitory computer readable medium having stored thereon a program that when executed by a computer causes the computer to:
generate first image data for a first image to be displayed on a display screen of a display;
cause the display to display the first image on the display screen;
receive an input signal in response to a swipe input having a direction;
generate second image data for a second image to be displayed on the display screen in response to the received input signal; and
cause the display to display a third image on a portion of the display screen, the portion of the display screen being on a side of the display screen opposite the direction of the swipe input, while the display is generating the second image data to be displayed on the display screen.

19. The non-transitory computer readable medium of claim 18, wherein
the swipe input is a first swipe input and the direction is a first direction, and
the program when executed by the computer causes the computer to cause the display to stop displaying the second image in response to a second swipe input having a second direction, the second direction being an opposite direction to the first direction.

20. The non-transitory computer readable medium of claim 18, wherein
the portion of the display screen is a first portion of the display screen, and
the program when executed by the computer causes the computer to generate fourth image data for a fourth image to be displayed on the display screen in response to a swipe input having a third direction, the third direction being different from the direction and a direction opposite to the direction.
